(19) United States
(12) Patent Application Publication
(10) Pub. No.: US 2024/0428281 A1
(43) Pub. Date: Dec. 26, 2024

(54) SYSTEMS AND METHODS FOR ANTICIPATING, IDENTIFYING, AND DEFENDING AGAINST ACTIVIST SHORT SELLERS AND PROVIDING AUTOMATED ADVISORIES

(71) Applicant: JPMORGAN CHASE BANK, N.A., New York, NY (US)

(72) Inventors: Ziqi ZHANG, London (GB); Jack LEE, London (GB); Sean KILGARRIFF, London (GB)

(21) Appl. No.: 18/748,998

(22) Filed: Jun. 20, 2024

Related U.S. Application Data
(60) Provisional application No. 63/509,874, filed on Jun. 23, 2023.

(51) Int. Cl. G06Q 30/0201; G06Q 40/04

(52) U.S. Cl. CPC G06Q 30/0206; G06Q 40/04

(57) ABSTRACT

A method may include: (1) retrieving information from websites for a plurality of activist short sellers; (2) identifying, from the information, a release of a report on a target company by one of the plurality of activist short sellers; (3) retrieving market data on the target company; (4) identifying, using a machine learning model, a movement in a share price for the target company based on the market data; (5) identifying an impact of the report on the share price for the target company; (6) identifying a business impact on investors or potential investors of the target company; (7) generating a business recommendation based on the impact of the report on the share price for the target company and the business impact on the investors or potential investors; and (8) identifying a mitigating action based on historical mitigation actions.

### RELATED APPLICATIONS

This application claims priority to, and the benefit of, U.S. Provisional Patent Application Ser. No. 63/509,874, filed Jun. 23, 2023, the disclosure of which is hereby incorporated by reference in its entirety.

### BACKGROUND OF THE INVENTION

### 1. Field of the Invention

Embodiments relate to systems and methods for anticipating, identifying, and defending against activist short sellers and providing automated advisories.

### 2. Description of the Related Art

Investors lose billions in deals to activist short sellers every month. Short Sellers are funds or research firms that published reports alleging issues at target companies and take profits from tarnishing the target companies' reputations.

### SUMMARY OF THE INVENTION

Systems and methods for anticipating, identifying, and defending against activist short sellers and providing automated advisories are disclosed. In one embodiment, a method may include: (1) retrieving, by an orchestration computer program executed by an electronic device, information from websites for a plurality of activist short sellers; (2) identifying, by the orchestration computer program and from the information, a release of a report on a target company by one of the plurality of activist short sellers; (3) retrieving, by the orchestration computer program, market data on the target company; (4) identifying, by the orchestration computer program and using a machine learning model, a movement in a share price for the target company based on the market data; (5) identifying, by the orchestration computer program, an impact of the report on the share price for the target company; (6) identifying, by the orchestration computer program, a business impact on investors or potential investors of the target company; (7) generating, by the orchestration computer program, a business recommendation based on the impact of the report on the share price for the target company and the business impact on the investors or potential investors; and (8) identifying, by the orchestration computer program, a mitigating action based on historical mitigation actions.

In one embodiment, the step of retrieving information from websites for a plurality of activist short sellers may include: controlling, by the orchestration computer program, a plurality of web scrapers to extract the information from the websites.

In one embodiment, the market data may be retrieved from a market data service.

In one embodiment, the machine learning model may be trained on historical short reports, an industry, a region, and/or a market cap.

In one embodiment, the movement in share price may be identified when the movement is above a threshold.

In one embodiment, the method may also include: generating, by the orchestration computer program, a notification to the investors in response to the movement in share price being detected.

In one embodiment, the business impact may be identified in response to the movement in share price being negative and above a threshold.

In one embodiment, the business recommendation may include establish a relationship, maintain the relationship, or terminate the relationship.

In one embodiment, the method may also include: ranking, by the orchestration computer program, the impact on the share price of report with impacts on share prices from other reports.

In one embodiment, the method may also include: generating, by the orchestration computer program, a summary of the report using a large language model.

According to another embodiment, a non-transitory computer readable storage medium may include instructions stored thereon, which when read and executed by one or more computer processors, cause the one or more computer processors to perform steps comprising: retrieving information from websites for a plurality of activist short sellers; identifying, from the information, a release of a report on a target company by one of the plurality of activist short sellers; retrieving market data on the target company; identifying, using a machine learning model, a movement in a share price for the target company based on the market data; identifying an impact of the report on the share price for the target company; identifying a business impact on investors or potential investors of the target company; generating a business recommendation based on the impact of the report on the share price for the target company and the business impact on the investors or potential investors; and identifying a mitigating action based on historical mitigation actions.

In one embodiment, retrieving information from websites for a plurality of activist short sellers includes instructions stored thereon, which when read and executed by the one or more computer processors, cause the one or more computer processors to perform steps comprising: controlling a plurality of web scrapers to extract the information from the websites.

In one embodiment, the market data may be retrieved from a market data service.

In one embodiment, the machine learning model may be trained on historical short reports, an industry, a region, and/or a market cap.

In one embodiment, the movement in share price may be identified when the movement is above a threshold.

In one embodiment, the non-transitory computer readable storage medium may also include instructions stored thereon, which when read and executed by the one or more computer processors, cause the one or more computer processors to perform steps comprising: generating a notification to the investors in response to the movement in share price being detected.

In one embodiment, the business impact may be identified in response to the movement in share price being negative and above a threshold.

In one embodiment, the business recommendation may include establish a relationship, maintain the relationship, or terminate the relationship.

In one embodiment, the non-transitory computer readable storage medium may also include instructions stored thereon, which when read and executed by the one or more computer processors, cause the one or more computer processors to perform steps comprising: ranking the impact on the share price of report with impacts on share prices from other reports.

In one embodiment, the non-transitory computer readable storage medium may also include instructions stored thereon, which when read and executed by the one or more computer processors, cause the one or more computer processors to perform steps comprising: generating a summary of the report using a large language model.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for anticipating, identifying, and defending against activist short sellers and providing automated advisories according to an embodiment;

FIG. 2 illustrate a method for anticipating, identifying, and defending against activist short sellers and providing automated advisories according to an embodiment;

FIG. 3 depicts an exemplary computing system for implementing aspects of the present disclosure.

### DETAILED DESCRIPTION OF PREFERRED EMBODIMENTS

Embodiments relate to systems and methods for anticipating, identifying, and defending against activist short sellers and providing automated advisories.

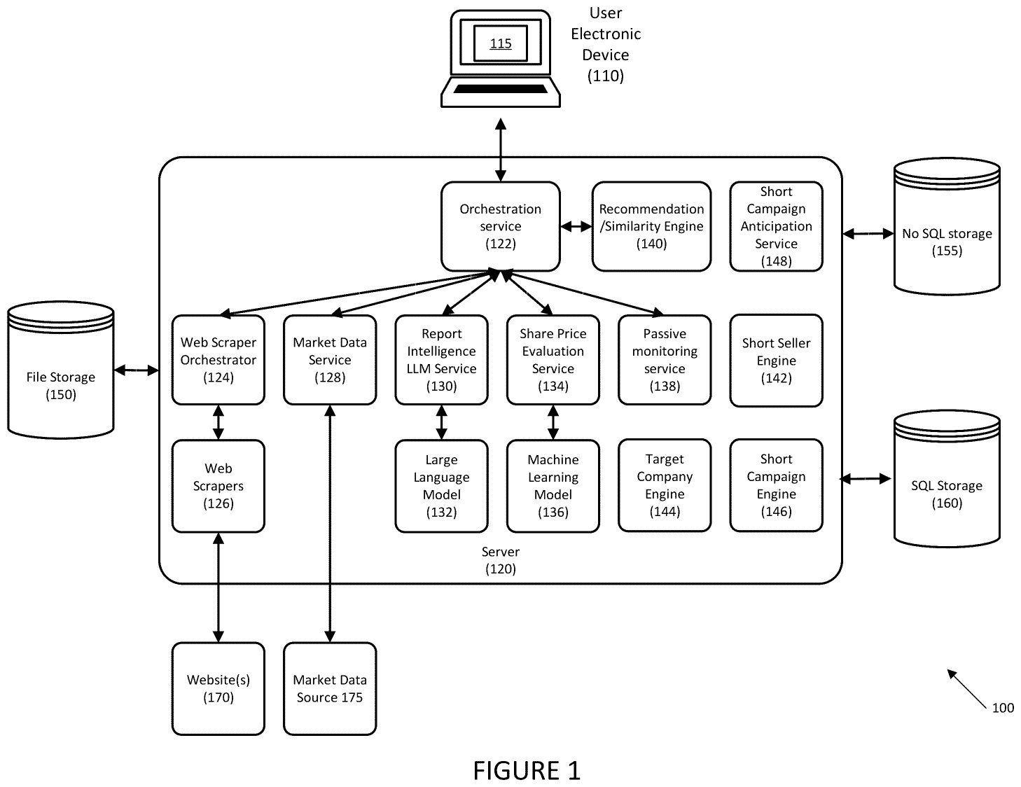

Referring to FIG. 1, a system for anticipating, identifying, and defending against activist short sellers and providing automated advisories according to an embodiment. System 100 may include user electronic device 110, which may be any suitable electronic device (e.g., computers, smart devices, Internet of Things appliances, etc.). User electronic device 110 may execute user interface 115, which may be a computer program, a browser application etc., that may interface with orchestration service 122 executed by server 120.

Server 120 may be a physical server and/or a cloud-based server.

Server 120 may execute a plurality of programs or services that may be managed and controlled by orchestration service 122, such as web scraper orchestrator 124 that may manage and control the operation of web scraper(s) 126, market data service 128, report intelligence large language model (LLM) service 130 that may interface with large language model 132, share price evaluation service 134 that may interface with machine learning model 136, passive monitoring service 138, recommendation/similarity engine 140, short seller engine 142, target company engine 144, short campaign engine 146, and short campaign anticipation service 148.

Server 120 and/or the programs or services may interface with file storage 150, No SQL storage 155, and SQL storage 160.

Web scraper orchestrator 124 may control web scrapers 126 to identify and extract information from reports from websites 170 for certain entities that may be considered to be “activist short sellers.” The extracted information may be provided to report intelligence LLM service 130, which may analyze the extracted information using LLM 132. For example, LLM 132 may predict an impact that the extracted information may have on the target company's share price, and a risk of share price deterioration.

Share price evaluation service 134 may monitor share prices for target companies, and may identify when potential shorts are in place, such as by monitoring activities of the activist short sellers. In one embodiment, share price evaluation service 134 may use machine learning model 136 to identify the potential shorts. In one embodiment, orchestration service 122 may generate an alert when a potential short is identified. The alert may notify investors and managers of a potential negative impact on share price.

Machine learning model 136 may also predict a business impact based on the potential negative share price. In one embodiment, machine learning model 136 may be trained using historical short campaign information. For example, based on the particular short sell activist, the industry, the region, the allegation, etc., it may predict an impact on share price and business restructurings of a target company that may be required over different time horizon.

Recommendation/similarity engine 140 may provide a recommendation as to whether to establish a relationship, to maintain a relationship, or to terminate a relationship with the target company. The considerations may impact the harm to, for example, the investor, whether the target company is a strategic client, the expected decline, etc.

Passive Monitoring service 138 may analyze, for example, news, market data, regulatory filings, etc., for certain companies and may evaluate the risks of being targeted by a short campaign.

Market data service 128 may retrieve market data on the target companies from market data source 175. For example, market data service 128 may receive real time financial information on the companies targeted, including share prices, bond prices, short interest, etc. as well as any news related to the targeted companies.

Market data services 128 may also play a role in identifying and anticipating upcoming short campaigns. For example, short campaign anticipation service 148 may combine negative news and short interests from market data services 128 and, leveraging historical short campaigns information, may identify the target for potential short campaigns and the potential short sellers.

Recommendation/similarity engine 140 may use semantic searches to identify historical activist short reports that are similar to a recently published activist short report, retrieved by web scraper 126. For example, recommendation/similarity engine 140 may use semantic searching and may leverage information from share price evaluation service 134, report intelligence LLM service 130, and any other services to make these recommendations. The recommendation/similarity engine 140 may consider, for example, the potential harm to, for example, the investor, whether the target company is a strategic client, the expected decline, etc.

Thus, a user may query recommendation/similarity engine 140 to see the impact of similar, historical activist short reports and study the response of the target of the historical activist short reports. Recommendation/similarity engine 140 may convert the historical activist short reports into text embeddings and store them in a vector database. The recently published activist short report may be similarly converted and may be used to query the vector database to find similar historical activist short reports.

File storage 150 may store, for example, reports from the extracted information retrieved by web scrapers 126 (e.g., short reports), and summaries of the short reports (e.g., generated by LLM 132).

No SQL storage 155 may store, for example, information on short sellers, short reports (e.g., reports retrieved by web scrapers 126), as well as information regarding target companies. For each target company, No SQL storage may store a name, a stock ticker, an industry, a region, a stock exchange, recent deals, client executives, etc. For short sellers, No SQL storage may store names, latest companies targeted, history of targets, short campaign performance, etc.

In one embodiment, No SQL storage 155 may include a plurality of databases. For example, a first No SQL database may be an elastic search database and may include a first collection of data, such as short report metadata (e.g., report timestamp, short seller, target company, stock ticker, industry), and a second collection of data, such as the report ingested from file storage 150.

The second No SQL database may be a MongoDB, and may include a first collection of target company data (e.g., target company name, stock ticker, industry, region, stock exchange, recent deals, client executives, short sellers, stock and bond prices, etc.), and a second collection including short seller data (e.g., short seller names, latest companies targeted, history of targets, short campaign performance, etc.).

SQL storage 160 may include market data, such as current prices, historical prices, report information (e.g., title, short seller, target company, website link, etc.), etc. For example, SQL storage 160 may include a plurality of tables, such as a table of short seller information (e.g., name, CEOs, latest reports, etc.), a second table of target company information (e.g., name, region, industry, market cap, CEO, stock ticker, etc.), a table of short campaign information (e.g., short report link, short report title, short seller, target company, timestamp, campaign status, campaign outcome, etc.).

Short seller engine 142 may be responsible for consolidating all information on short sellers. For example, for on-going campaigns, short seller engine 142 may identify the start dates, allegations, short position, latest updates (news announcement), etc., and for past campaigns, may identify the impact and outcome (bankruptcy, share price impact, etc.), etc. It may further identify the shot sellers' average impact on share pieces and latest announcements.

Target company engine 144 may identify target company details, such as share price, bond price, etc., short allegations, client executives, previous engagements, deal information, and recommendations how to engage the target company.

Short campaign engine 146 may identify the short sellers, short positions by all funds, short interests, allegations, etc.

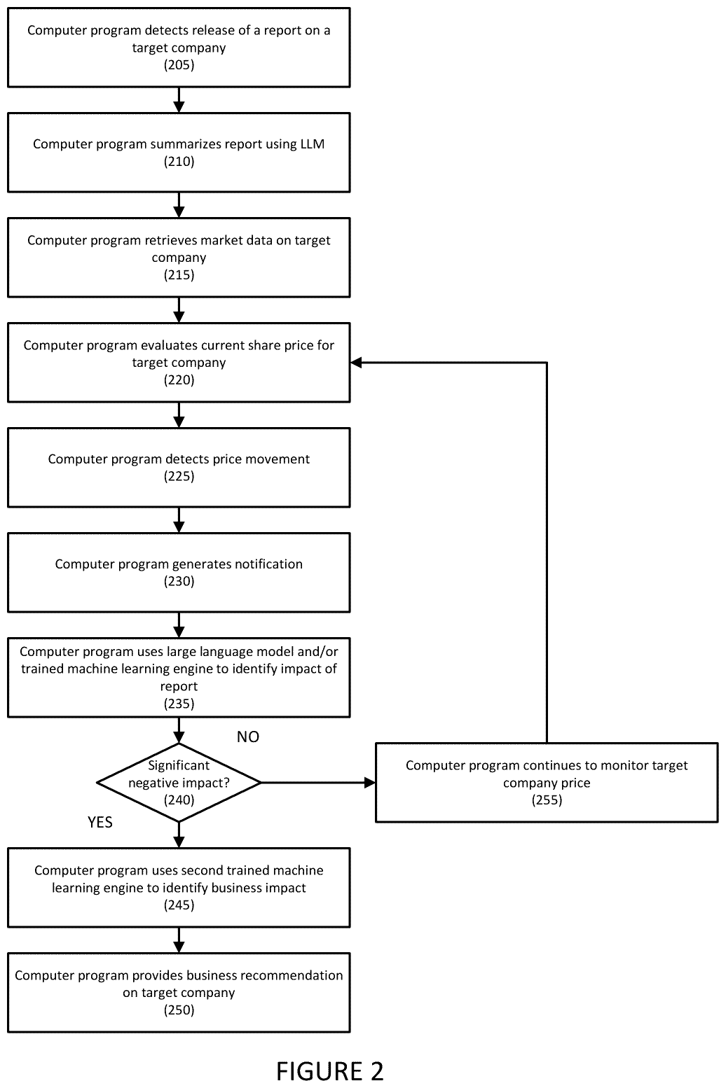

Referring to FIG. 2, a method for anticipating, identifying, and defending against activist short sellers and providing automated advisories is disclosed according to an embodiment.

In step 205, a computer program, such as an orchestration computer program, may identify the release of a report on the target company by an activist short seller of interest. For example, the computer program may use web scrapers to extract information from websites of activist short sellers and other relevant websites and may store the information in a database.

For example, the web scrapers may periodically execute a job (e.g., every few seconds, hourly, daily, etc.) or may be manually triggered to execute a job to scrape information from websites of interest.

In step 210, the computer program may generate a summary of the report using, for example, a LLM engine. The computer program may save the summary in the database.

In step 215, the computer program may retrieve market data on one or more target companies. For example, the computer program may access a market data service to retrieve real-time share price and target company financial information for one or more target companies.

In step 220, the computer program may evaluate the current share price for the target companies using, for example, a machine learning model. The machine learning model may be trained on historical short reports, industry, region, market cap, etc. to evaluate share price movement. The share price may be stored, for example, in No SQL storage.

In step 225, the computer program may detect a price movement for the target company. In one embodiment, the price movement may be required to be above a threshold before a price movement is detected.

In step 230, the computer program may generate notification(s) to investors, managers, etc.

In step 235, the computer program may identify an impact of the report on the target company using, for example, a LLM or a trained machine learning engine. For example, the computer program may use keywords extracted from the report, a summary of the report, etc. to compare to keywords in historical reports to determine the potential impact on the target company, such as on the share price.

In step 240, if there is a significant negative impact (a threshold for which may be dynamic, may be set by the investors, etc.), in step 245, the computer program may use a trained machine learning engine to identify business impact on investors. The machine learning model may be the same as the machine learning engine used in step 230, or it may be a different machine learning engine.

In step 250, the computer program may provide a business recommendation on the target company. For example, the computer program may recommend whether to establish a relationship, to maintain a relationship, or to terminate a relationship with the target company. The considerations may impact the harm to, for example, the investor, whether the target company is a strategic client, the expected decline, etc.

In one embodiment, with evaluation of historical short campaigns, and based on actions taken by target companies and the outcomes of these actions, the computer program may identify the potential mitigation steps for a given company, for a given region, and for a given allegation.

In one embodiment, the computer program may automatically implement the mitigating steps.

Examples of mitigating steps include stabilizing the share price by initiating a share buy-back program, delisting from the market, providing working capital by establishing or extending a credit line, spinning off part of business to improve operational efficiency and retain significant working capital, etc.

In step 255, if there is not a significant negative impact, the computer program may continue to monitor the target company price. The results may be used to re-train the machine learning engine(s).

In one embodiment, the results may also be provided to an activist short seller ranking model that may rank the impact of activist short reports on the share price relative to activist short reports from other activist short sellers. For example, the computer program may retrieve real-time pricing information for companies, real-time short interest, real time short position disclosures, and real time share price information. Based on historical short campaigns, and based on the market movements before a short campaign, the computer program may evaluate the likelihood of companies being targeting.

Embodiments may also identify short seller collusion with hedge funds, so using this pattern, the computer program may identify potential short sellers.

Illustrative examples are as follows:

Company A has been subject to multiple short seller attacks, and its share price is down 7.8% due to an attack by a short seller that accuses it of financial manipulation. The reputational risk is minimal as Company A has a credible and solid business plan. Using the AI model and LLM, embodiments may stabilize Company A's share price by initiating a share buy-back program or a delisting from the market.

As another example, two months after its IPO, Company B was targeted by an activist short seller. Embodiments capture the events and with automated analysis on short reports and allegation. It was determined that the reputational risk and potential transaction fraud by Company B was significant, and that exposure should be reduced. However, potential late stage mitigation measures were recommended: (1) sell side mandate. a company under short attack may spin off part of business to improve operational efficiency and retain significant working capital; (2) transaction during delisting from the public market.

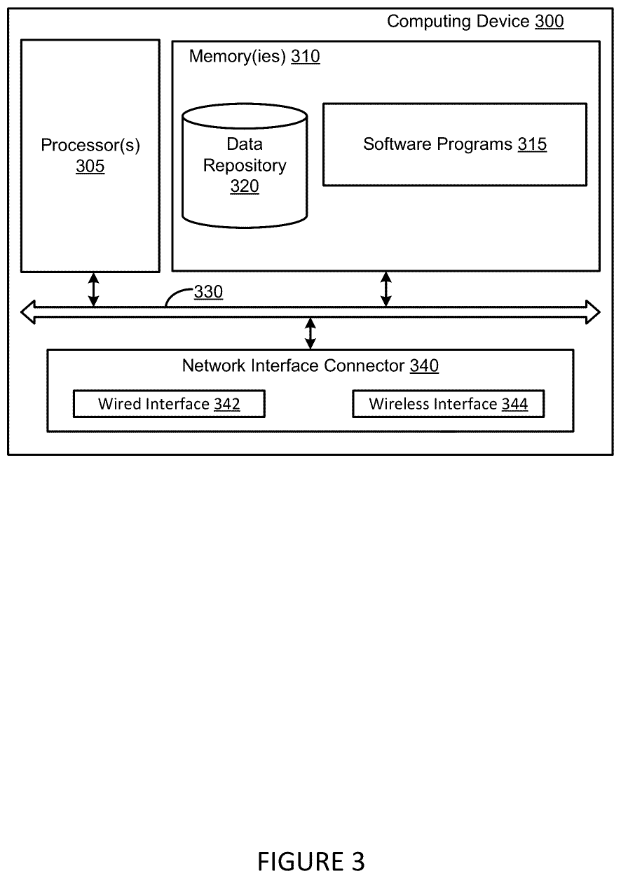

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
retrieving, by an orchestration computer program executed by an electronic device, information from websites for a plurality of activist short sellers;
identifying, by the orchestration computer program and from the information, a release of a report on a target company by one of the plurality of activist short sellers;
retrieving, by the orchestration computer program, market data on the target company;
identifying, by the orchestration computer program and using a machine learning model, a movement in a share price for the target company based on the market data;
identifying, by the orchestration computer program, an impact of the report on the share price for the target company;
identifying, by the orchestration computer program, a business impact on investors or potential investors of the target company;
generating, by the orchestration computer program, a business recommendation based on the impact of the report on the share price for the target company and the business impact on the investors or potential investors; and
identifying, by the orchestration computer program, a mitigating action based on historical mitigation actions.

2. The method of claim 1, wherein retrieving information from websites for a plurality of activist short sellers comprises:
controlling, by the orchestration computer program, a plurality of web scrapers to extract the information from the websites.

3. The method of claim 1, wherein the market data is retrieved from a market data service.

4. The method of claim 1, wherein the machine learning model is trained on historical short reports, an industry, a region, and/or a market cap.

5. The method of claim 1, wherein the movement in share price is identified when the movement is above a threshold.

6. The method of claim 1, further comprising:
generating, by the orchestration computer program, a notification to the investors in response to the movement in share price being detected.

7. The method of claim 1, wherein the business impact is identified in response to the movement in share price being negative and above a threshold.

8. The method of claim 1, wherein the business recommendation comprises establish a relationship, maintain the relationship, or terminate the relationship.

9. The method of claim 1, further comprising:
ranking, by the orchestration computer program, the impact on the share price of report with impacts on share prices from other reports.

10. The method of claim 1, further comprising:
generating, by the orchestration computer program, a summary of the report using a large language model.

11. A non-transitory computer readable storage medium, including instructions stored thereon, which when read and executed by one or more computer processors, cause the one or more computer processors to perform steps comprising:
retrieving information from websites for a plurality of activist short sellers;
identifying, from the information, a release of a report on a target company by one of the plurality of activist short sellers;
retrieving market data on the target company;
identifying, using a machine learning model, a movement in a share price for the target company based on the market data;
identifying an impact of the report on the share price for the target company;
identifying a business impact on investors or potential investors of the target company;
generating a business recommendation based on the impact of the report on the share price for the target company and the business impact on the investors or potential investors; and
identifying a mitigating action based on historical mitigation actions.

12. The non-transitory computer readable storage medium of claim 11, wherein retrieving information from websites for a plurality of activist short sellers includes instructions stored thereon, which when read and executed by the one or more computer processors, cause the one or more computer processors to perform steps comprising:
controlling a plurality of web scrapers to extract the information from the websites.

13. The non-transitory computer readable storage medium of claim 11, wherein the market data is retrieved from a market data service.

14. The non-transitory computer readable storage medium of claim 11, wherein the machine learning model is trained on historical short reports, an industry, a region, and/or a market cap.

15. The non-transitory computer readable storage medium of claim 11, wherein the movement in share price is identified when the movement is above a threshold.

16. The non-transitory computer readable storage medium of claim 11, further including instructions stored thereon, which when read and executed by the one or more computer processors, cause the one or more computer processors to perform steps comprising:
generating a notification to the investors in response to the movement in share price being detected.

17. The non-transitory computer readable storage medium of claim 11, wherein the business impact is identified in response to the movement in share price being negative and above a threshold.

18. The non-transitory computer readable storage medium of claim 11, wherein the business recommendation comprises establish a relationship, maintain the relationship, or terminate the relationship.

19. The non-transitory computer readable storage medium of claim 11, further including instructions stored thereon, which when read and executed by the one or more computer processors, cause the one or more computer processors to perform steps comprising:
ranking the impact on the share price of report with impacts on share prices from other reports.

20. The non-transitory computer readable storage medium of claim 11, further including instructions stored thereon, which when read and executed by the one or more computer processors, cause the one or more computer processors to perform steps comprising:
generating a summary of the report using a large language model.
